(19) United States
(12) Patent Application Publication
(10) Pub. No.: US 2015/0121433 A1
(43) Pub. Date: Apr. 30, 2015

(54) Media Sharing System

(71) Applicant: Yang Pan, Singapore (SG)

(72) Inventor: Yang Pan, Singapore (SG)

(21) Appl. No.: 14/064,113

(22) Filed: Oct. 26, 2013

(51) Int. Cl. H04N 21/436; H04N 7/10; H04N 5/44; H04N 21/4788; H04N 21/41; H04N 21/422; H04N 21/431; H04N 21/478; H04N 21/4363; H04N 21/462

(52) U.S. Cl. CPC H04N 21/43615; H04N 21/43637; H04N 7/106; H04N 5/4403; H04N 21/4622; H04N 21/4126; H04N 21/4222; H04N 21/431; H04N 21/4781; H04N 21/4788; H04N 2005/4425; H04N 2005/4426
USPC 725/80

(57) ABSTRACT

A media sharing system includes a television system and at least a first set of smart phone and smart watch owned by a first user and a second set of smart phone and smart watch owned by a second user. Smart watches are connectable to the television system. One of the smart phones is employed as a remote control device. The media sharing system can access media assets stored in all of the smart watches using the smart phone as the remote control. In one implementation, the users need to play a game and the winner will use his or her smart phone to control the media item delivery.

### CROSS-REFERENCE TO RELATED APPLICATIONS

Not applicable.

### BACKGROUND

1. Field of Invention

This invention relates generally to a media asset delivery system. More specifically, the invention relates to sharing media assets stored in personal devices by employing a television system.

2. Description of Prior Art

Personal mobile devices have gained significant popularity in recent years. Users are using the mobile device such as, for example, iPhone, iPod and iPad from Apple Inc, Cupertino, Calif., to enjoy media assets and to access the Internet services. Methods for delivering video programs to users by employing personal mobile devices have been developed.

Because of significantly larger display size and comfortable environment in a living room, many of video programs have still been delivered to users through a television (TV) system. Media assets are stored in different personal devices. Sometimes, users may wish to share media assets through a common platform. Therefore, it is desirable to have an easy method for sharing media assets such as, for examples, video programs stored in personal devices of different users.

### SUMMARY OF THE INVENTION

It is an object of the present invention to provide media asset sharing system including a television system and a plurality of personal devices.

It is another object of the present invention to provide a control system for sharing media assets stored in a plurality of personal devices by the use of a television system.

An exemplary system in a generic form includes a media delivery unit and a plurality of pairs of mobile server/mobile client. Each of the pairs belongs to one user. The user's identity may be stored in the server and/or in the client. The clients are connectable to media delivery unit through ad hoc communication links. One of the servers is selected by the media delivery unit as a remote control device for the system. In one implementation, the server as the remote control device is connected to the media delivery unit through an ad hoc communication link. In another implementation, the server is connected to the television system through at least one of the clients. A media asset is selected by a user through the remote control device from media assets stored in all of the connected clients.

In one embodiment, the media delivery unit is a television system, the mobile server is a smart phone and the client is a smart watch.

The media delivery unit may also be a home audio system, a vehicle media system. The media delivery unit may also be a television system in a public area.

The mobile server may also be a tablet computer, a media player, a game console, a digital camera, a smart wearable device and a laptop computer.

The mobile client may also be a smart wearable device, a tablet computer, a media player, a digital camera, a game console and a laptop computer.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1A is a schematic diagram of an exemplary media sharing system in a generic form;

FIG. 1B is a schematic diagram of the exemplary media sharing system used for purchasing a media asset;

FIG. 2 is schematic diagram of an exemplary media sharing system in accordance with a first embodiment;

FIG. 3 is a flowchart illustrating operations of the media sharing system for rendering a media asset in accordance with the first embodiment;

FIG. 4 is schematic diagram of an exemplary media sharing system in accordance with a second embodiment;

FIG. 5 is a flowchart illustrating operations of the media sharing system for rendering a media asset in accordance with the second embodiment;

FIG. 6 is schematic diagram of an exemplary media sharing system in accordance with a third embodiment;

FIG. 7 is a flowchart illustrating operations of the media sharing system for rendering a media asset in accordance with one implementation of the third embodiment;

FIG. 8 is a flowchart illustrating operations of the media sharing system for rendering a media asset in accordance with another implementation of the third embodiment.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

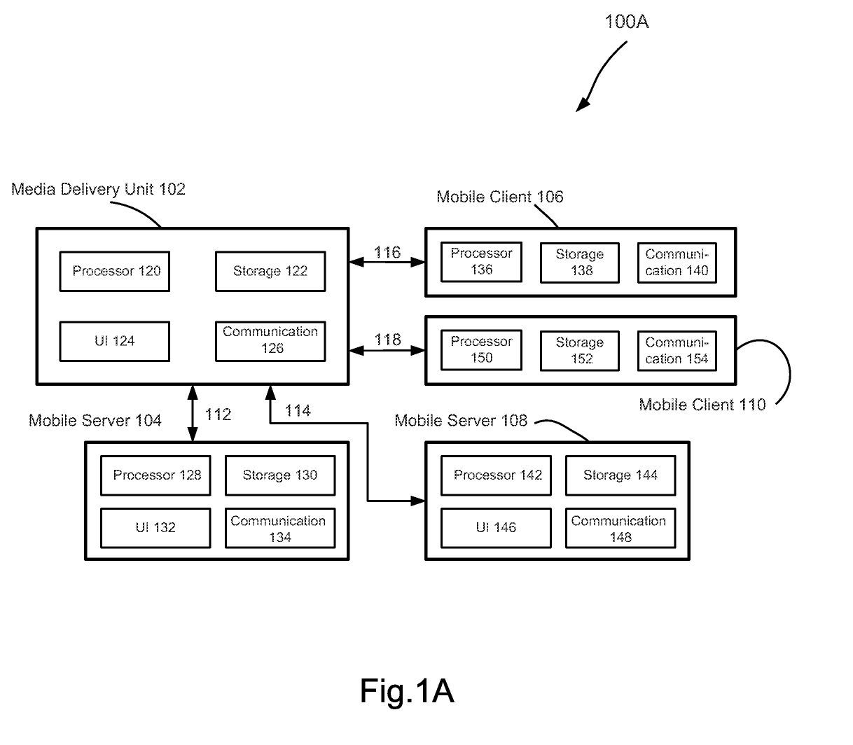

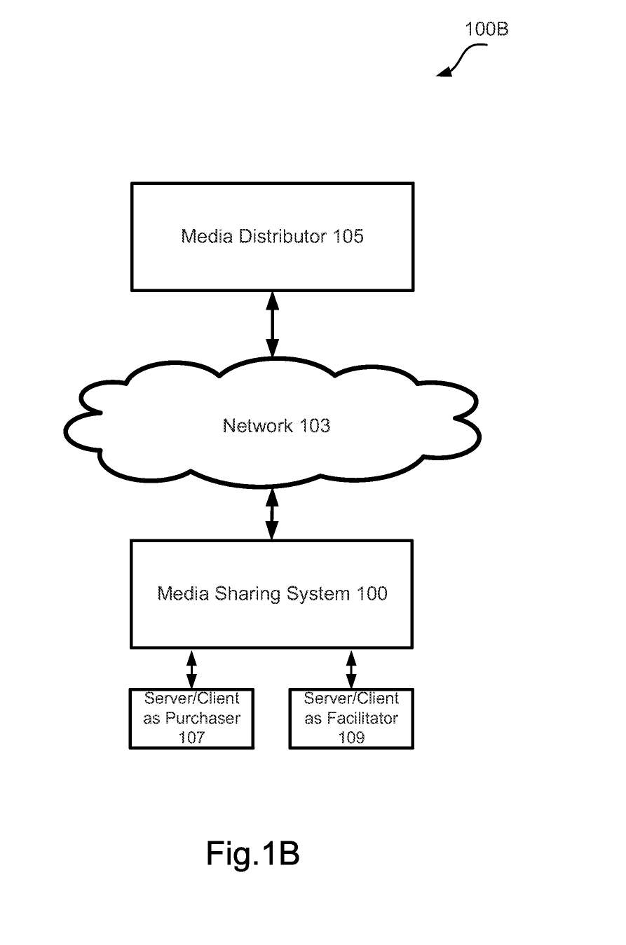

FIG. 1A is a schematic diagram illustrating an exemplary media sharing system 100A in a generic form. System 100A includes a media delivery unit 102, a first pair of mobile server 104 and mobile client 106 and a second pair of mobile server 108 and mobile client 110. The media delivery unit 102 includes but is not limited to a television system, a home audio system and a vehicle media system. The vehicle media system further includes an automobile media system and an airplane media system. The mobile server 104 and 108 include but are not limited to smart phones, tablet computers, laptop computers, media players, smart wearable devices, digital cameras and game consoles. The mobile client 106 and 110 include but are not limited to smart wearable devices, smart phones, tablet computers, laptop computers, media players, digital cameras and game consoles. In a preferred embodiment, the mobile servers are smart phones and the mobile clients are smart watches. Each pair of the server and client is associated with a user. The user's identity may be stored in the server and/or the client.

In one implementation, the mobile servers 104 and 108 are connectable to the media delivery unit 102 through ad hoc communication links 112 and 114, respectively. The mobile clients 106 and 110 are connectable to the media delivery unit 102 through ad hoc communication links 116 and 118, respectively. The ad hoc communication links may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). In another aspect, ad hoc communication links 116 and 118 are wired connections including docking systems.

One of the mobile servers may be used as a remote control device pertaining to controlling of transferring a media asset from one of the clients to the media delivery unit. The media asset is subsequently rendered by the media delivery unit.

In another implementation (not shown in the figure), the mobile server as the remote control device is connected to the media delivery unit through one of the clients. The media server and the client are connected through an ad hoc communication link similar to ad hoc communication links 112 and 114.

The media delivery unit 102 comprises a processor 120, a data storage unit 122, a user interface (UI) 124 and a communication unit 126.

The server 104 comprises a processor 128, a data storage unit 130, an UI 132 and a communication unit 134.

The client 106 comprises a processor 136, a data storage unit 138, and a communication unit 140.

The server 108 comprises a processor 142, a data storage unit 144, an UI 146, and a communication unit 148.

The client 110 comprises a processor 150, a data storage unit 152, and a communication unit 154.

After the mobile servers 104 and 106 are connected to the media delivery unit 102, one of the servers is selected by the processor 120 of the media delivery unit 102 as the remote control device. In one aspect, the selection is based upon timings of establishing the connections. The first connected server is selected as the remote control device. In another aspect, identities of the users are transmitted from the clients or the servers to the media delivery unit. Processor 120 selects the server as the remote control device based upon a predetermined algorithm. The predetermined algorithm includes a predetermined priority for the users. In yet another aspect, the users may play a game and the server associated with the winner will be used as the remote control device. The game can be rendered by processor 120 through a display of the media delivery unit 102.

After the clients are connected to the media delivery unit 102, media assets stored in the storage units 138 and 152 are accessible to the media delivery unit 102. In one embodiment, UI 124 includes two user interfaces for accessing the media assets stored in the storage units 138 and 152, independently by one of the users employing one of the servers as the remote control device. In another embodiment, metadata of the media assets stored in the clients are transmitted to the media delivery unit 102 and are organized into a single hierarchical structure. UI 124 displays metadata of the media assets as if they are stored in a single data storage unit. One of the users can select a media asset through the UI 124 by using one of the servers as the remote control device. Selected media asset is rendered by processor 120 by the use of the media delivery unit 102 accordingly.

In an exemplary case, the server 104 is selected as the remote control device. Processor 128 receives an input from the user through a user input device of the server 104 (not shown in the figure). In response to the user's selection, processor 128 transmits a control signal to the media delivery unit 102 through the ad hoc communication link 112. Processor 120 receives the control signal from the communication unit 126. In response to the received control signal, processor 120 may display another hierarchical level of UI 124 or retrieve a selected media asset from one of the clients through either communication unit 140 or communication unit 154.

In another aspect, the communication units 126, 134, 140, 148 and 154 can be used to form an ad hoc communication network for transferring data and control signals among the media delivery unit 102 and the servers 104, 108 and the clients 106 and 110.

In an exemplary case, a media library for a user may be stored in both the storage unit 130 and storage unit 140. The media assets stored in server 104 and in client 106 can be synchronized in accordance with a predetermined frequency.

In another implementation, metadata of the media assets stored in server 108 or in client 110 can be transmitted to server 104 directly. UI 132 can be employed to display a hierarchical UI on a display of the server 104. The user can select a media asset by using the server 104. Selected metadata is transmitted from the server 104 to the media delivery unit 102 through the ad hoc communication link 112. In response to received metadata, processor 120 retrieves the associated media asset from either client 106 or client 110 and renders selected media asset accordingly.

The media sharing system 100A can be used to facilitating an operation of purchasing a media asset. As shown in FIG. 1B, media sharing system 1 OOB is connected to a media distributor 105 connected to a network 103. In an exemplary case, the network 103 is the Internet. The media sharing system 100B includes a purchaser 107 comprising server 104 and client 106 and a facilitator 109 comprising server 108 and client 110. The user of server 104 can purchase a media asset stored in server 108 or client 110. After discovering the media asset through UI 124, the user sends a purchase request through server 104 to the media delivery unit 102. Upon receiving the purchasing request, processor 120 transmits the request to the media distributor 105 through the network 103. The user's purchasing request can be granted after the user pays for the media asset. The purchased media asset can be stored in storage unit 138 of the client 106 or in the storage unit 130 of the server 104. The purchase media asset may be delivered from the media distributor 105 or from client 110 or server 108 with an authorization from the media distributor 105. Server 108, by facilitating the purchasing, can receive a credit from the media distributor 105.

The present inventive concept can be readily extended to more than two pairs of mobile server and client. Further, server 104 and server 108 can take a different form. For example, server 104 may be a smart phone and server 108 may be a tablet computer. Client 106 and client 110 may also take a different form. For example, client 106 may be a smart watch and client 110 may be a media player.

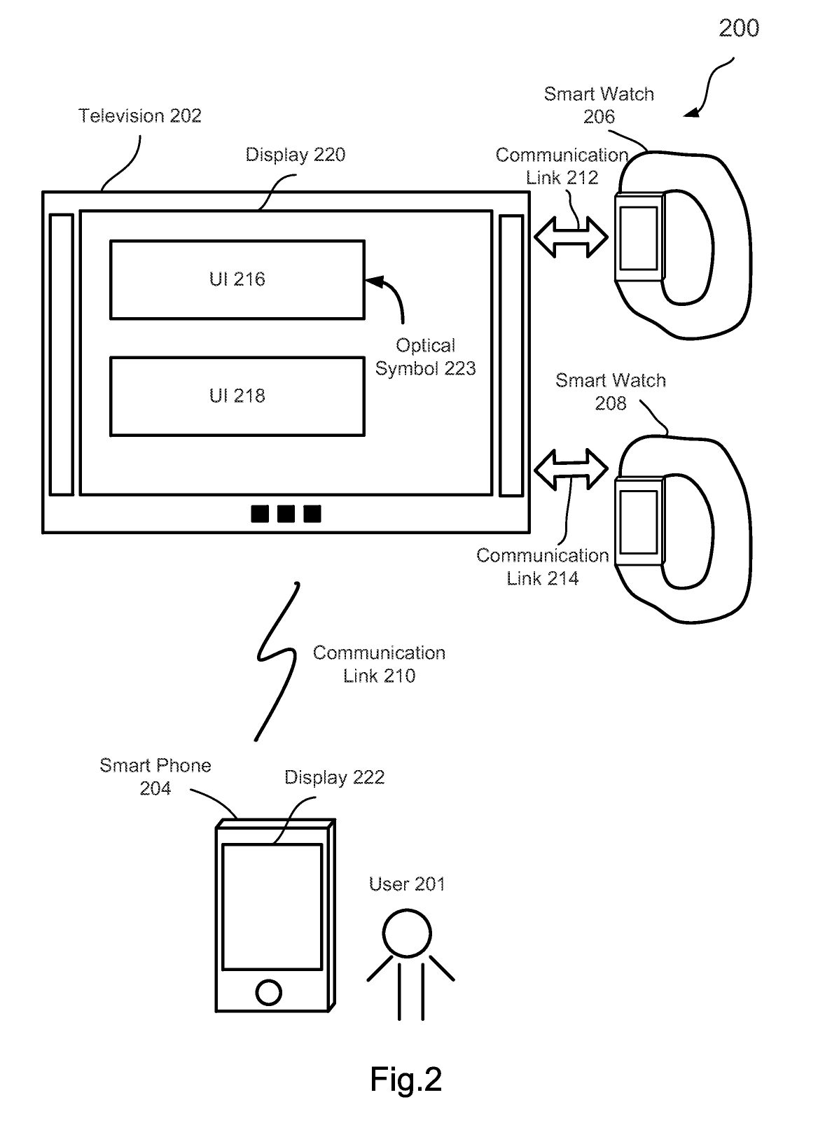

FIG. 2 is schematic diagram of an exemplary sharing system 200 in accordance with a first embodiment. In the exemplary system 200, a television system 202 is used as the media delivery unit. A smart phone 204 is used as mobile server paired with a smart watch 106 as the mobile client. The pair belongs to user 201. The identity of user 201 may be stored in smart phone 204 or in smart watch 206. The smart phone 204 is used as a remote control device. In an exemplary implementation, smart phone 204 is connected to the television system 202 through an ad hoc communication link 210. The smart watch 206 is connected to the television system 202 through an ad hoc communication link 212. Another smart watch 208 belonging to another user is connected to the television system 202 through an ad hoc communication link 214. The ad hoc communication links may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). In another implementation, communication links 212 and 214 are wired connections including docking systems. Smart watch 208 as the mobile client is paired with another smart phone (not shown in the figure).

After smart watches 206 and 208 are connected to the television system 202, metadata of media assets stored in the watches are transmitted to the television system 202 through the communication links 212 and 214. In response to received metadata, the processor in television system 202 displays a first UI 216 for accessing the media assets stored in smart watch 206 and a second UI 218 for accessing the media assets stored in smart watch 208. The UI 216 and UI 218 may be hierarchical user interfaces. The smart phone 204 is used as the remote control device for selecting a media asset through UI 216 and UI 218 displayed on display 220. Selected media asset is retrieved by the processor in the television system 202 from either smart watch 206 or smart watch 208. Selected media asset such as, for example, a video program is rendered by the television system 202 accordingly.

The smart phone 204 includes a display 222. In an exemplary case, the display 222 comprises a touch-sensitive display. User 201 touches the display 222 using a finger and generates a control signal. The control signal is transmitted from smart phone 204 to the television system 202 through the communication link 210. A processor in the smart phone 204 and the processor in the television system 202 synchronize movements of the finger on display 222 and movements of an optical symbol 223 on the display 220. An operation of touching down by the finger on the display 222 actuates a selection of a displayed item on the display 220.

A media library of user 201 can be stored in smart phone 204 and in smart watch 206. Media assets stored in the smart phone 204 and in the smart watch 206 are synchronized in accordance with a predetermined frequency.

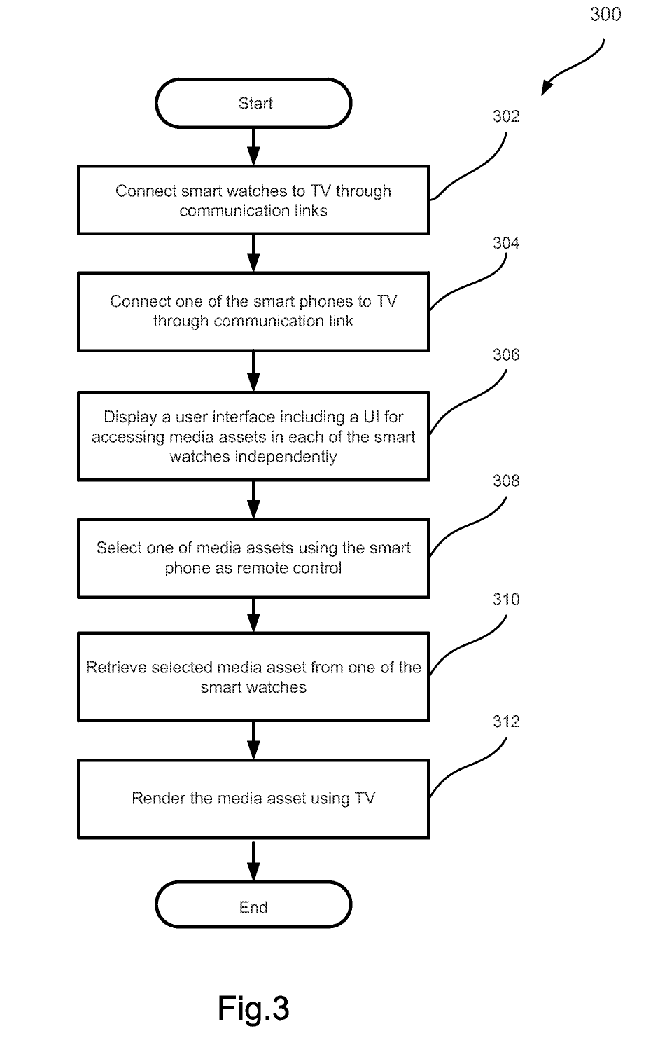

FIG. 3 is a flowchart illustrating operations of the exemplary media sharing system 200. Process 300 starts with step 302 that at least two smart watches are connected to the television system through ad hoc communication links. Each of the smart watches is paired with a smart phone. Each smart phone and smart watch belongs to a user. In step 304, one of the smarts phones is connected to the television system 202 through the ad hoc communication link 210 as the remote control device. UI 216 and UI 218 are displayed on display 220 of the television system 202 in step 306. UI 216 and UI 218 may be hierarchical user interfaces. In step 308, user 201 selects a media asset using the smart phone as the remote control device. In response to the user's selection, the processor in the television system 202 retrieves the media asset from one of the smart watches in step 310. The retrieved media asset is rendered using the television system 202 in step 312.

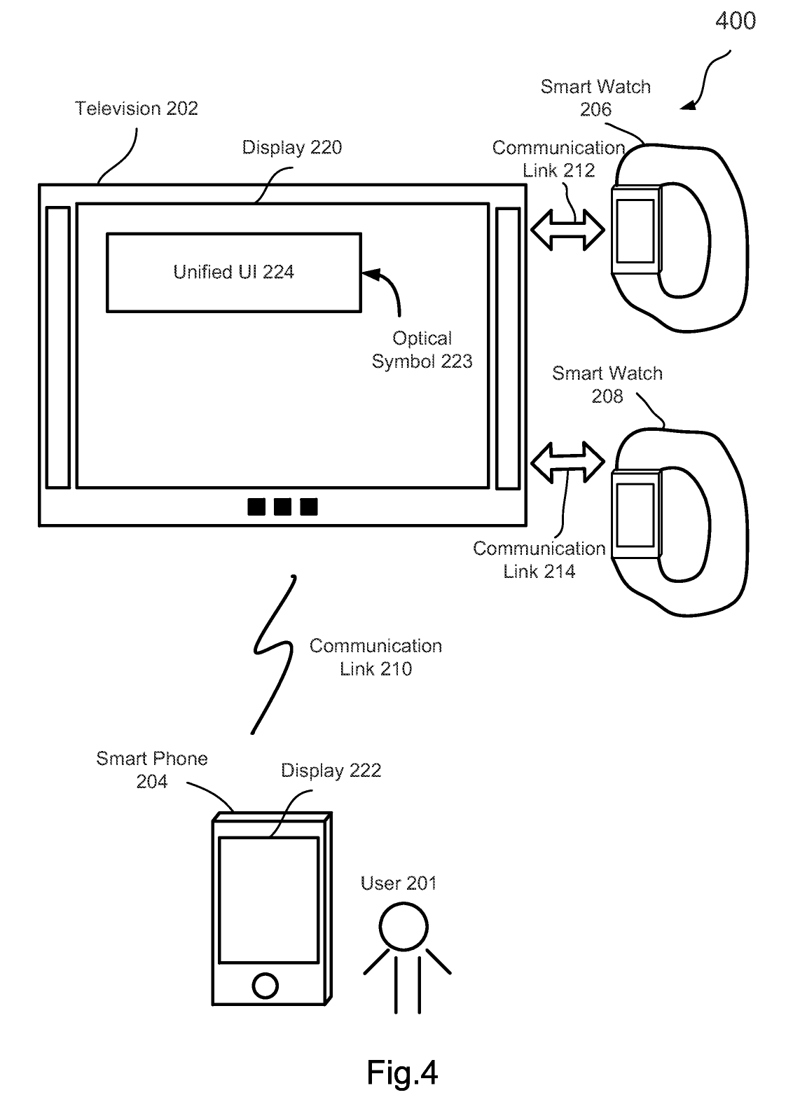

FIG. 4 is schematic diagram of an exemplary media sharing system 400 in accordance with a second embodiment. System 400 is similar to system 300 except that a unified UI 224 is displayed on display 220 for accessing the media assets stored in smart watch 206 and in smart watch 208. Metadata of the media assets in smarts 206 and 208 are transmitted to the television 202 through communication links 212 and 214. Received metadata for the media assets are organized in a single hierarchical structure and are displayed through the unified UI 224.

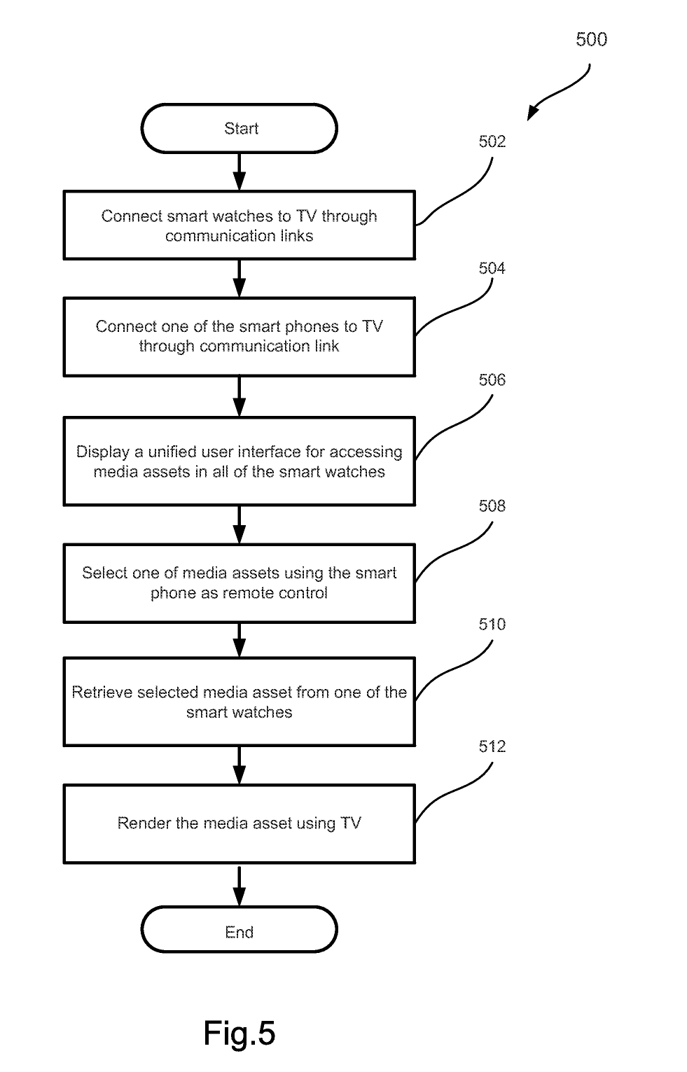

FIG. 5 is a flowchart illustrating operations of the media sharing system 400. Process 500 starts with step 502 that at least two smart watches are connected to the television system through ad hoc communication links. Each of the smart watches is paired with a smart phone. Each smart phone and smart watch belongs to a user. In step 504, one of the smarts phones is connected to the television system 202 through the ad hoc communication link 210 as the remote control device. The unified UI 224 for all of the media assets stored in smart watches 206 and 208 is displayed on display 220 of the television system 202 in step 506. UI 224 may be hierarchical user interfaces. In step 508, user 201 selects a media asset using the smart phone as the remote control device. In response to the user's selection, the processor in the television system 202 retrieves the media asset from one of the smart watches in step 510. The retrieved media asset is rendered using the television system 202 in step 512.

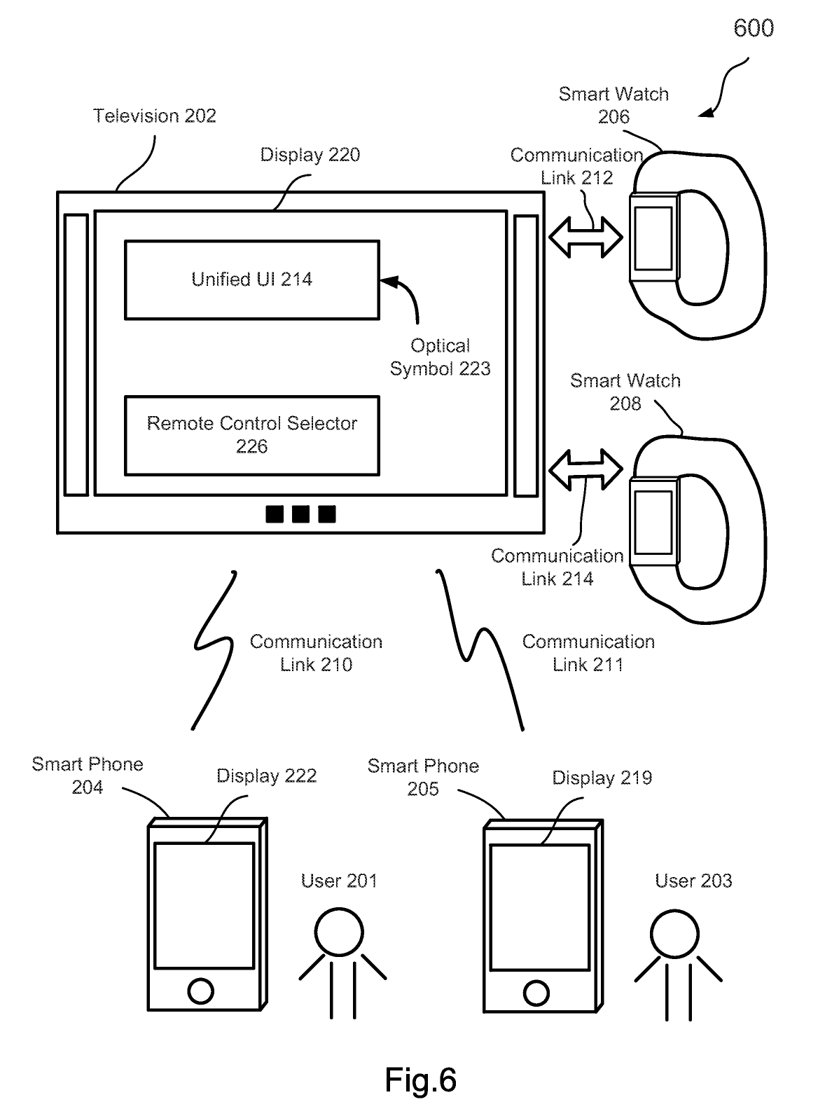

FIG. 6 is schematic diagram of an exemplary media sharing system 600 in accordance with a third embodiment. System 600 is similar to system 400 except that a smart phone 205 is connected to the television 202 through an ad hoc communication link 211. The smart phone 205 is paired with smart watch 208 and belongs to user 203. The television system 202 further includes a remote control selector 226. Remote control selector 226 is a software program stored in a data storage unit of the television system 202 and is executable by the processor in the television system 202. After the smart phones 204 and 205 are connected to the television system 202, remote control selector 226 selects one of the smart phones as the remote control device. In one aspect, the smart phone connected to the television system first is selected as the remote control device.

In another aspect, the users of the smart phones are identified by the television system. The remote control device is selected by remote control selector based upon a predetermined rule in accordance with the identities of the user. The identities of the users may be stored in the smart phones or in the smart watches. The identities may be transmitted from the smart phones or the smart watches to the television system through the ad hoc communication links. The identities of the users may also be determined by biometric sensors such as, for example, fingerprint sensors, image sensors or eye iris sensors. The sensors may be installed in the smart phones or in the television system.

In yet another aspect, a game may be played by user 201 and user 203 by the use of the television system 202. The winner of the game gains control of the media sharing system through his or her smart phone. In an exemplary case, a ball may be bounced in a back and forth manner on displayed 220. The user catches the ball first using his or her smart phone will be granted as a controlling user of the media sharing system.

In an alternative implementation, UI's for different smart watches may be displayed on display 220 independently rather than a single unified UI is displayed.

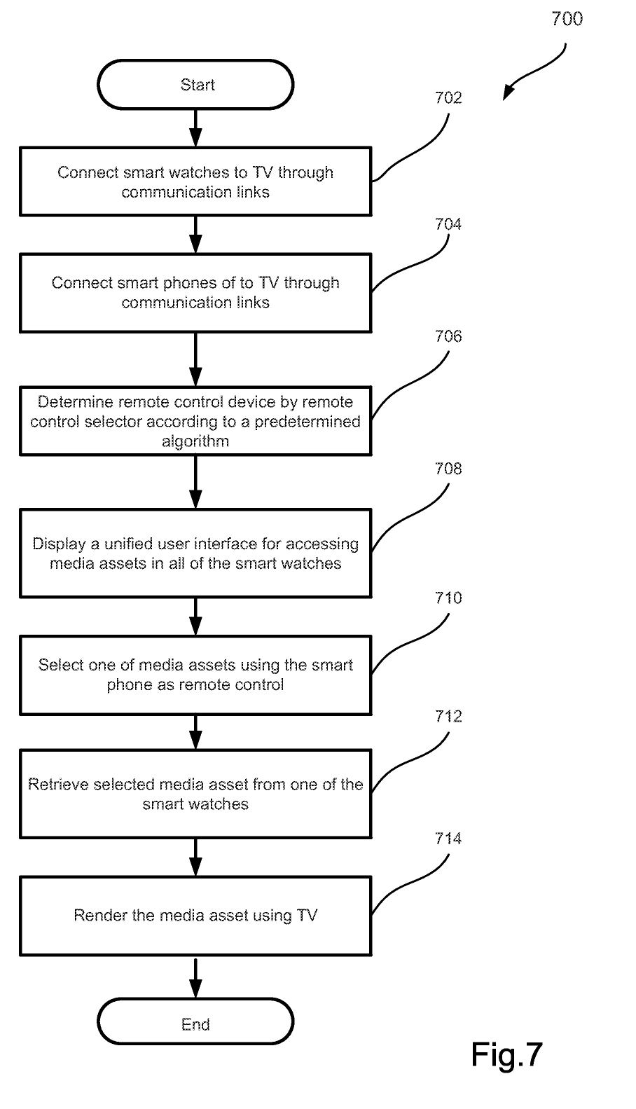

FIG. 7 is a flowchart illustrating operations of the media sharing system 600. Process 700 starts with step 702 that at least two smart watches are connected to the television system through ad hoc communication links. Each of the smart watches is paired with a smart phone. Each smart phone and smart watch belongs to a user. In step 704, smarts phones are connected to the television system 202 through the ad hoc communication links 210 and 211 as candidates as the remote control device. In step 706, one of the smart phones is selected by remote control selector 226 according to a predetermined algorithm as describe the previous sessions. The unified UI 224 for all of the media assets stored in smart watches 206 and 208 is displayed on display 220 in step 708. UI 224 may be hierarchical user interfaces. In step 710, the user of selected smart phone selects a media asset using the smart phone as the remote control device. In response to the user's selection, the processor in the television system 202 retrieves the media asset from one of the smart watches in step 712. The retrieved media asset is rendered using the television system 202 in step 714.

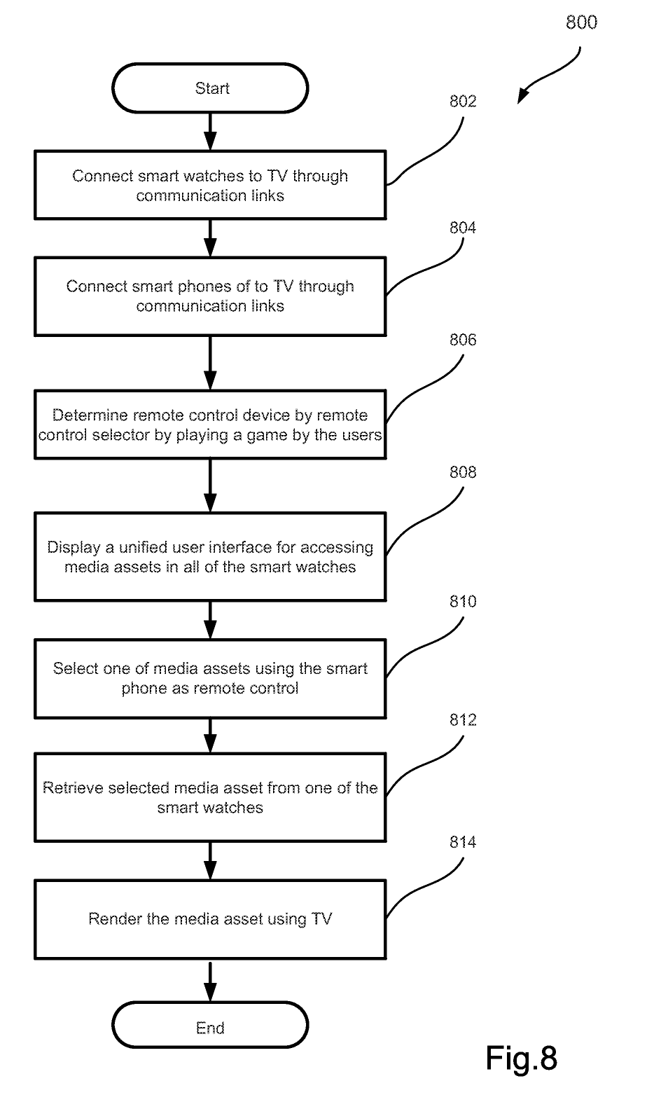

FIG. 8 is a flowchart illustrating operations of the media sharing system 600. Process 800 starts with step 802 that at least two smart watches are connected to the television system through ad hoc communication links. Each of the smart watches is paired with a smart phone. Each smart phone and smart watch belongs to a user. In step 804, smarts phones are connected to the television system 202 through the ad hoc communication links 210 and 211 as candidates as the remote control device. In step 806, one of the smart phones is selected by remote control selector 226 according to a result of a video game played by user 201 and 203. The unified UI 224 for all of the media assets stored in smart watches 206 and 208 is displayed in step 808. UI 224 may be hierarchical user interfaces. In step 810, the user of selected smart phone selects a media asset using the smart phone as the remote control device. In response to the user's selection, the processor in the television system 202 retrieves the media asset from one of the smart watches in step 812. The retrieved media asset is rendered using the television system 202 in step 814.

1. A media sharing system comprising:
a. a television system; and
b. a plurality of pairs of smart phone and smart watch, each of said pairs is associated with a user,
wherein each of said smart watches is connected to said television system through one of a plurality of ad hoc communication links,
wherein one of said smart phones is selected by said television system as a remote control device pertaining to controlling of retrieving and rendering a media asset stored in one of said smart watches.

2. The system as recited in claim 1, wherein said smart phone is selected by said television system as a remote control device based upon a result of a video game played by the users employing said television system.

3. The system as recited in claim 1, wherein at least one of the identities of the users is transmitted from one of the smart watches to said television system.

4. The system as recited in claim 1, wherein at least one of the identities of the users is transmitted from one of the smart phones to said television system.

5. The system as recited in claim 1, wherein said smart phone is selected by said television system based upon identities of the users in accordance with a predetermined rule.

6. The system as recited in claim 1, wherein a user interface is displayed on a display of said television system, said user interface is pertaining to selecting said media asset from said smart watches.

7. The system as recited in claim 6, wherein said user interface further comprising a plurality of user interfaces, each of said plurality user interfaces is associated with one of said smart watches.

8. The system as recited in claim 6, wherein said user interface further comprising a unified user interface for all of the media assets stored in said smart watches.

9. The system as recited in claim 1, wherein said system further comprising a means for purchasing a media asset.

10. The system as recited in claim 1, wherein said ad hoc communication links further comprising a Bluetooth type of connection or a Near Field Communication type of connection.

11. A media sharing system comprising:
a. a television system;
b. a plurality of pairs of smart phone and smart watch, each of said pairs is associated with a user; and
c. a user interface displayed on said television system pertaining to receiving an instruction from one of said smart phones and to retrieving a media asset from one of said smart watches.

12. The system as recited in claim 11, wherein said smart phone is selected by said television system as a remote control device based upon a result of a game played by the users through said television system.

13. The system as recited in claim 11, wherein at least one of the identities of the users is transmitted from one of the smart watches to said television system.

14. The system as recited in claim 11, wherein at least one of the identities of the users is transmitted from one of the smart phones to said television system.

15. The system as recited in claim 11, wherein said smart phone is selected by said television system based upon identities of the users in accordance with a predetermined rule.

16. The system as recited in claim 11, wherein said user interface further comprising a plurality of user interfaces, each of said plurality user interfaces is associated with one of said smart watches.

17. The system as recited in claim 11, wherein said user interface further comprising a unified user interface for all of the media assets stored in said smart watches.

18. A media sharing system comprising:
a. a television system; and
b. a plurality of pairs of mobile server and mobile client, each of said pairs is associated with a user,
wherein each of said clients is connected to said television system through one of a plurality of ad hoc communication links,
wherein one of said mobile server is selected by said television system as a remote control device pertaining to controlling of retrieving and rendering a media asset stored in one of said mobile clients.

19. The system as recited in claim 18, wherein said mobile server as the remote control device is connected to said television system through at least one of said mobile clients, wherein said mobile server is connected to said client device through another ad hoc wireless communication link.

20. The system as recited in claim 18, wherein said system further comprising a means for purchasing a media asset by a user.
